(19) United States
(12) Patent Application Publication
(10) Pub. No.: US 2006/0066159 A1
(43) Pub. Date: Mar. 30, 2006

(54) Fluid-passage built-in type electric rotating machine

(76) Inventors: Yuji Enomoto, Hitachi (JP); Shoji Ohiwa, Iwatsuki (JP); Ryoso Masaki, Hitachi (JP); Chio Ishihara, Tokyo (JP)

Correspondence Address: CROWELL & MORING LLP;INTELLECTUAL PROPERTY GROUP, P.O. BOX 14300, WASHINGTON, DC, 20044-4300, US

(21) Appl. No.: 11/201,119

(22) Filed: Aug. 11, 2005

(30) Foreign Application Priority Data
Sep. 30, 2004 (JP) 2004-287643

(51) Int. Cl. H02K 9/20; H02K 9/00

(52) U.S. Cl. 310/54; 310/58

(57) ABSTRACT

A fluid-passage built-in type electrical rotating machine, which comprises a rotor fixed to a rotating shaft by means of a bearing; a stator in rotating relation to the rotor with a gap therebetween; a housing surrounding the stator; a pump turbine, fixed to one end of the rotating shaft, for circulating fluid in the electrical rotating machine; a first end bracket fixed to one end of the housing; and a second end bracket fixed to the other end of the housing. The first end bracket has a suction port for suctioning fluid into the electrical rotating machine, and the second end bracket has a discharging port for discharging fluid from the electrical rotating machine. The outer periphery of the stator and the inner face of the housing confines a first fluid flow passage extending along the axis of the rotating shaft, one end of the stator iron core and the first end bracket facing the one end of the stator confines a second fluid flow passage and the other end of the stator and the second end bracket confines a third fluid flow passage.

### CLAIM OF PRIORITY

This application claims priority from Japanese application serial No. 2004-287643, filed on Sep. 30, 2004, the content of which is hereby incorporated by reference into this application.

### FIELD OF THE INVENTION

The present invention related to a fluid-passage built-in type electric rotating machine such as a motor, a generator, etc, and more particularly to an electric rotating machine having fluid flow passages for flowing a liquid, a cooling medium, a fuel or gas.

### RELATED ART

Electric rotating machines wherein fluid is flown inside the machines have been proposed in such as Japanese patent laid-open 2004-03433. This type of electrical rotating machines are called fluid-passage built-in type electrical rotating machines.

### DESCRIPTION OF THE INVENTION

The fluid-passage built-in type electric rotating machines have a gap between a stator and a rotor for flowing the fluid. Because of flow resistance due to the narrow gap, a transportation efficiency of the fluid is low and stirring loss of fluid by the rotor generates in the rotating machines.

### SUMMARY OF THE INVENTION

It is an object of the present invention to provide a fluid-passage built-in type electric rotating machine having fluid flow passages inside the machine, which eliminates lowering of fluid transportation efficiency and removes stirring loss.

In order to satisfy the above object, the present invention provides a fluid-passage built-in type electric rotating machine wherein a fluid flow path is formed of a suction port through a portion near the core back to a discharge port, the fluid suction port for the flow passage and the fluid discharging port, which are formed at fixing members of the rotating machine near the core back of the stator iron core.

According to the above-mentioned structure, the fluid never flows through the gap between the stator and the rotor. As a result, a decrease in the fluid transportation efficiency in the narrow gap between the stator and the rotor will not occur. Further, since the stirring of the fluid by the rotor does not occur, stirring loss is prevented.

According to the fluid-passage built-in type electric rotating machine of the present invention, the stirring loss by the rotor is prevented, without lowering of fluid transportation efficiency.

### BRIEF DESCRIPTION OF THE DRAWINGS

FIG. 1 is a vertical cross sectional view of an electrical rotating machine of one embodiment according to the present invention.

FIG. 2 is a perspective view of a stator iron core of the electrical rotating machine shown in FIG. 1.

FIG. 3 is a plan view of the electrical rotating machine shown in FIG. 1.

FIG. 4 is a developed view of the electrical rotating machine shown in FIG. 1.

FIG. 5 shows a structure of the stator iron core of the electrical rotating machine shown in FIG. 1.

FIG. 6 is a process for manufacturing the stator of the electrical rotating machine shown in FIG. 1.

FIG. 7 shows a modified structure of a stator iron core corresponding to that of FIG. 2.

FIG. 8 shows a segment structure used in the stator iron core shown in FIG. 7.

FIG. 9 is a perspective view of the stator iron core molded with resin.

FIG. 10 is another example of the modified stator iron core of the electrical rotating machine shown in FIG. 1.

FIG. 11 is a plan view of a stator iron core segment constituting the stator of the electrical rotating machine shown in FIG. 10.

FIG. 12 is a perspective view of the stator iron core segment constituting the stator iron core.

FIG. 13 is a modified example of the stator iron core segment shown in FIG. 12.

FIG. 14 is a perspective view of a modified example of the stator iron core.

FIG. 15 is a plan view of the stator iron core shown in FIG. 14.

FIG. 16 is a perspective view of a part of the stator iron core, seal grooves being formed at the end of the stator iron core.

FIG. 17 is a plan view of the stator iron core end having seal grooves.

FIG. 18 a elevational cross sectional view of a modified electrical rotating machine having flow passages inside the machine according to the present invention.

### DETAILED DESCRIPTION OF THE PREFERRED EMBODIMENTS

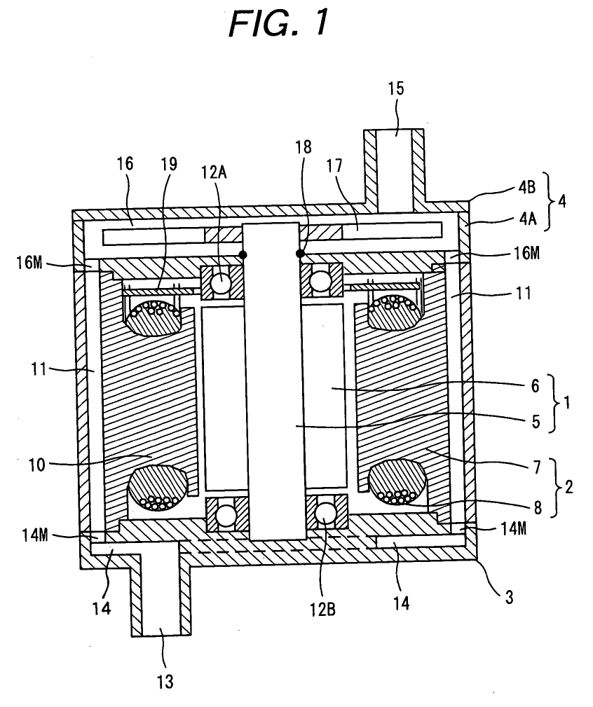

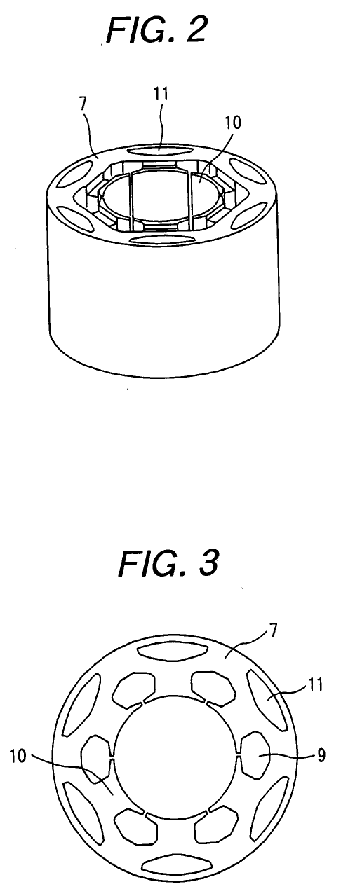

In the following, embodiments shown in FIGS. 1 to 4 of the electrical rotating machine having fluid flow passages inside the machine according to the present invention will be explained. The electrical rotating machine shown in FIGS. 1 to 4 is a motor of a permanent magnet type for a pump, which comprises a rotor 1, a stator 2 disposed to keep a small gap with the rotor 1 and end brackets 3, 4, which are located at the ends of the rotor 1 and hold the rotor 1 and the stator 2 in a predetermined position relation. The end brackets 3, 4 are part of fixing members of the electrical rotating machine.

The rotor 1 has a rotor 5 and a rotor core 6 provided with a permanent magnet (not shown) formed on the rotor 5. The stator 2 comprises a stator iron core 7 and a core winding 8 wound in grooves 9 of the stator iron core. The stator iron core 7 is made of a sintered magnetic core of a compacted molded magnetic powder, or a molded core composed of magnetic powder or a mixture of a magnetic powder and another magnetic material. The stator iron core 7 constitutes a plurality of winding grooves 9 in which the stator winding 8 is wound and teeth portions 10 formed between the winding grooves 9 at the side opposed to the rotor 1. At the core back side, a first fluid flow passage 11 that penetrates through the stator iron core at positions opposite to the roots of the teeth 10 or the positions between the adjoining winding grooves 9.

An axial length at the core back side of the stator iron core is longer than an axial length at the teeth portion. The outer peripheries of the end brackets 3, 4 are fixed to the both ends of the core back side. In this specification, the end bracket 3 is called a primary end bracket and the second end bracket 4 is called a secondary end bracket for distinguishing them from the first end bracket 4A and the second end bracket 4B.

A rotating shaft 5 is supported by bearings 12A, 12B inside the stator iron core to maintain the positional relationship between the rotor 1 and the stator 2. The end bracket 3 is provided with a fluid suction port 13 and a second fluid flow passage 14 that communicates with the suction port 13 is provided coaxially with the rotating shaft 5. The opening 14M of the second fluid flow passage 14 is formed at a position which is opposite to one opening of a first fluid flow passage 11.

On the other hand, the end bracket 4 is constituted by a first end bracket 4A and a second end bracket 4B, wherein the second end bracket 4B is provided with a fluid discharge port 15 and a third fluid flow passage 16 that communicates with the fluid discharge port 15 is disposed between the first end bracket 4A and the second end bracket 4B in a coaxial relation with the rotating shaft 5. The opening 16M of the third fluid flow passage 16 is formed at a position opposite to an opening at the other end of the first fluid flow passage 11, which is formed in the stator iron core 7.

Further, an end of the rotating shaft 5 projects into the third fluid flow passage 16 confined by the end bracket 4. A pump turbine 17 for circulating or transporting fluid is disposed to the projection. The pump turbine 17 may be located within the second fluid flow passage 14 in accordance with types of motors or applications of motors. A seal member 18 such as an O-ring or a V-ring is disposed between the projected shaft 5 and the end bracket 4. A wiring board 19 for connecting ends of stator coils 8 is disposed to a fixing portion around the shaft 12A.

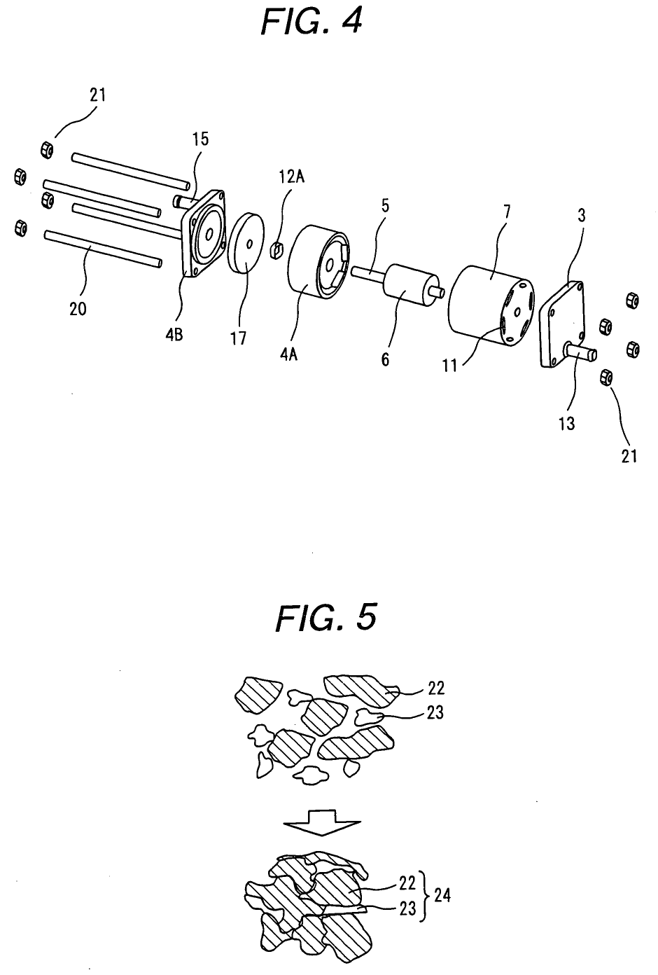

In the above-mentioned structure, the end bracket 3, the stator iron core 7, the first end bracket 4A and the second end bracket 4B are fastened by inserting fastening bolts 20 and nuts 21 (shown in FIG. 4) so that the first fluid flow passage, the second fluid flow passage 14 and the third fluid flow passage 16 are fluid-tightly communicated to form a fluid flow path passing through the core back side of the stator iron core.

By forming the fluid flow passage, since the fluid does not flows around the stator 1, it is possible to eliminate disadvantages that occur in circulating the fluid around the rotor 1. That is, by rotating the pump turbine 17 driven by the motor shaft, the fluid entering from the suction port 13 flows through the second fluid flow passage 14, the opening 14M, the first fluid flow passage 11, the opening 16M, the third fluid flow passage 16, the pump turbine 17 and flows out from the discharging port 15. Since the fluid does not flow between the rotor 1 and the stator 2, there is no decrease in the fluid transportation efficiency that was caused by flow resistance in the narrow passage between the rotor 1 and the stator 2. Further, since the rotor 1 does not stir the fluid, there is no loss of the rotating machine caused by fluid stirring.

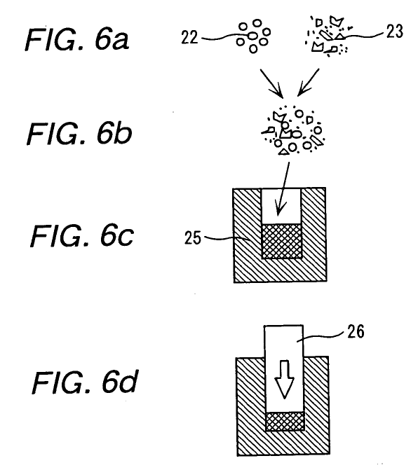

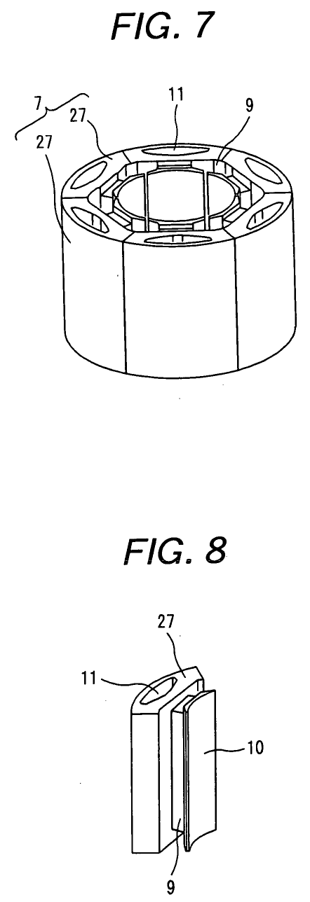

In this embodiment, the stator iron core 7 is made of sintered iron core of compacted magnetic powder or made of iron core of a compacted mixture of magnetic powder and metallic powder. An example of methods of preparing the stator iron core 7 will be explained by reference to FIGS. 5 and 6 in the following.

A main material for the compacted iron core is magnetic material such as pure iron. The particles of the magnetic powder are coated with the insulating film such as oxide film to obtain magnetic powder 22 with an insulating film shown in FIG. 5(a). The insulated magnetic powder 22 is mixed with a binder resin 23, and the mixture is press-molded to obtain a compacted magnetic body 24 shown in FIG. 5(b).

The compacted magnetic body 24 is placed in a mold 25 having a cavity of the stator iron core 7. Then, the compacted magnetic body 24 is pressed with a punch 26. The particles of the insulated magnetic powder 22 entangle each other to obtain a compacted magnetic body 24 having the shape of the stator iron core 7.

In the above case, the stator iron core 7 is a single body of the compacted magnetic body. In the case of large sized stator iron cores, a large press device for generating a large molding pressure is needed. Furthermore, winding of stator winding 8 in the winding grooves 9 has to be done in a narrow space between the teeth portions 10, which was a troublesome work.

In the present embodiment, as shown in FIGS. 8 and 9, 6 segments 27 of the compacted magnetic body are prepared by dividing the stator into 6 segments at the winding groves when there are 6 winging grooves in the motor. The 6 stator segments 27 are assembled to obtain the stator 2. According to this method, each of the segments 27 for constituting the stator 2 has a small volume; the molding of the segments can be done under a smaller molding pressure than the pressure molding of the single body stator. Therefore, a large-scale press-molding device is not needed. Since each of the signets 27 has an open shape for winding grooves, i.e. the winding grooves are opened wherein the teeth portions 10 are in the center as shown in FIG. 8, winding on the winding grooves can be done extremely easily. That is, there are no narrow spaces between teeth portions that are an obstacle for winding.

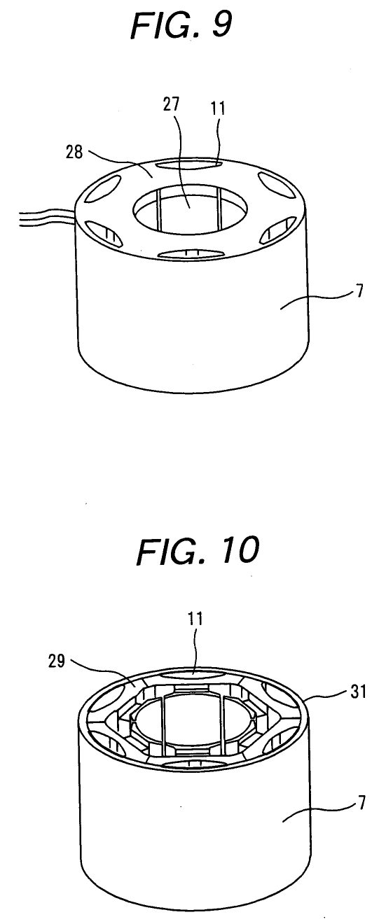

After winding of the coil 8 on the segments, the stator iron core 7 is constituted by assembling the segments 27. Then, the surface of the stator iron core 7 other than the surface that faces the rotor is molded with resin 28 as shown in FIG. 9 to unite the assembled segments 27.

In the above embodiment, the first fluid flow passage 11 is formed by a through-hole extending in the axial direction within the outer periphery of the stator 7. The first fluid flow passage 11 may be formed in the manner disclosed in FIGS. 10 to 13.

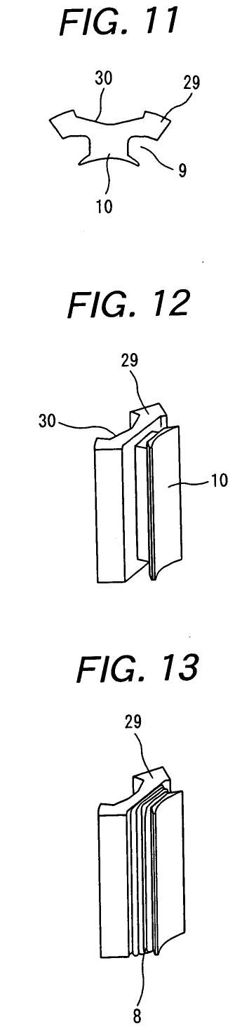

As shown in FIGS. 12 and 13, stator segments 29 are prepared in a shape that is obtained by equally dividing a stator iron core, a top view (FIG. 11) of each of the segments being identical. Each of the segments 29 has a groove 30 extending though the axial length of the segments as shown in FIG. 12. After the stator winding 8 is disposed in the grooves 9 as shown in FIG. 13, the segments are assembled and the assembled segments are inserted into a cylindrical housing 31 shown in FIG. 10 to constitute the stator iron core 7 as shown in FIG. 10. As shown in FIG. 10, the fluid flow grooves 30 are confined by the cylindrical housing 31 and the segments, so that the first fluid flow passages 11 are formed between the cylindrical housing 31 and the segments 29.

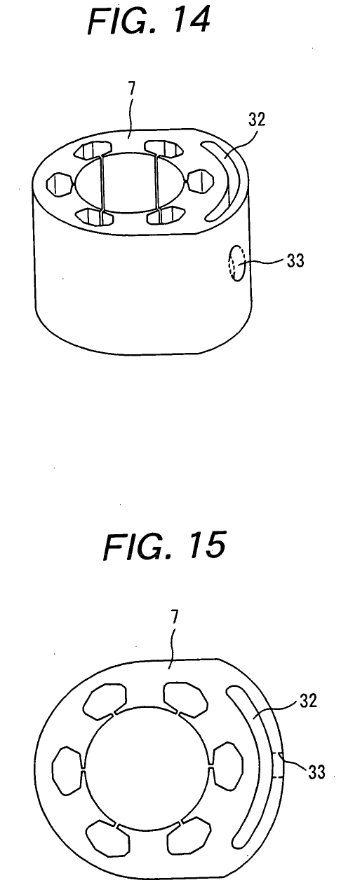

Although the above explanations are concerned with the embodiments wherein the fluid flow passages are formed without changing the outer diameter of the stator iron core 7, the outer diameter or contour of the stator iron core 7 may be changed in accordance with applications. FIGS. 14 and 15 show a perspective view and a top plan view of a modified stator iron core wherein a single first fluid flow passage 32 has a larger cross sectional area than that of other embodiments. The first fluid flow passage is formed as one passage at the core back side of the stator iron core 7. The first fluid flow passage 32 may not penetrate through the stator iron core 7 in the axial direction, and one end of the passage 32 may be opened to form an opening 33 at the outer surface of the stator iron core 7. The opening 33 works as a discharge port.

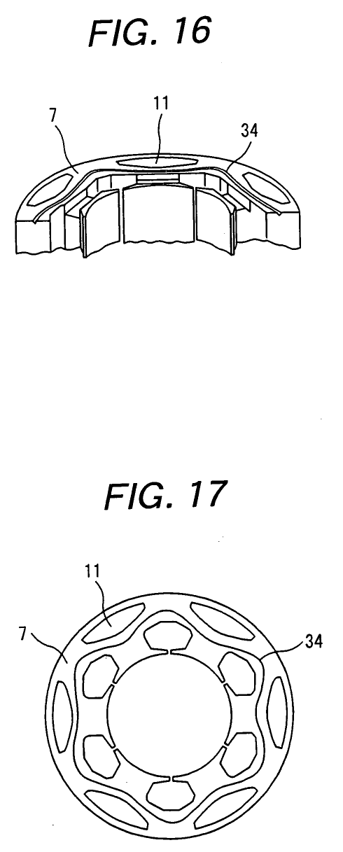

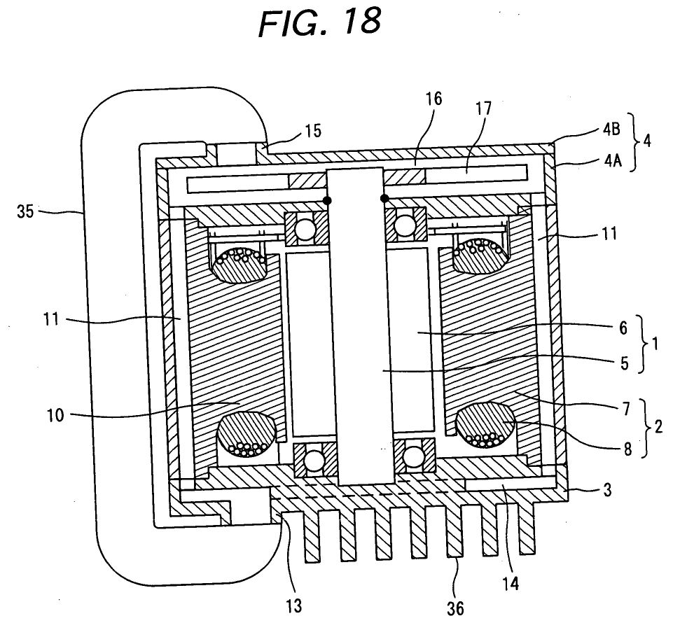

In the above embodiments, both ends of the stator iron core 7 in the axial direction are contacted with the end bracket 3 and the first end bracket 4A, and the first fluid flow passage 11 or 32, the second fluid flow passage 14 and the third fluid flow passage 16 are fluid-tightly fastened by fastening with the bolt 20 and nut 21. As shown in FIGS. 16 and 17, an endless sealing groove 34 may be formed at a position within the first fluid flow passage 11 or 32 of the stator iron core 7, at the time of forming the stator iron core 7. By filing an O-ring in the sealing groove 34 or coating a silicone sealant in the groove 34, the leakage of fluid from the connecting portions of the fluid flow passages is firmly prevented to provide electrical rotating machines with high reliability. The sealing groove 34 may be formed only at the end brackets 3, 4 side or may be formed at the brackets 3, 4 side and the stator iron core 7 side.

The above explanations are concerned with a pump motor as an electrical rotating machine having fluid flow passages in the machine. The present invention may be applied to a self-cooling electrical rotating machine shown in FIG. 18. The same reference numerals as in FIG. 1 are the same unless otherwise specified. Only the components differing from those in FIG. 1 are explained.

In this embodiment, the suction port 13 disposed at the end brackets 3, 4 and the discharge port 15 are communicated with a heat dissipating flow passage 35 to constitute a closed loop within which a cooling medium is confined. According to the above structure, heat generated in the electrical rotating machine upon operation of the machine is dissipated in the cooling medium flowing through the fluid flow passage (the first fluid flow passage 11, the second fluid flow passage 14 and the third fluid flow passage 16). The cooling medium heated by the heat from the electrical rotating machine moves to the fluid flow passage 35 to release heat into the atmosphere and to cool itself, which may be called a self-circulation. The cooled cooling medium again returns to the electrical rotating machine.

It is possible to prevent elevation of temperature of the electrical rotating machine because the electrical rotating machine is effectively cooled. It is also possible to increase a continuous rate point by increasing a driving current for the electrical rotating machine and to downsize the electrical rotating machine.

When fins 36 are disposed at one or more of the fluid flow passages (first fluid flow passage 11, second fluid flow passage 14, third fluid flow passage 16), the cooling efficiency will be further improved.

The above explanations are concerned with the stator iron core 7 made of compacted magnetic bodies; laminated silicon-steel plates may be employed. If the stator iron core is made of the silicon-steel plate laminate, the fluid may leak through the gaps between the laminated plates. In order to prevent the leakage, the inner face of the fluid flow passages may be coated with resin, or metal tubes or resin tubes may be inserted into the flow passages so as to prevent a direct contact of the fluid with the silicon-steel plate laminate.

In the above embodiments, the length of the stator iron core 7 in the axial direction at the core back side is longer than that of the teeth side thereby to connect with the end brackets 3, 4; if the length of the stator iron core 7 in the axial direction at the core back side is the same as the length of the teeth portions 10 so that the stator iron core 7 does not contact with the end brackets 3, 4, the stator iron core 7 is supported to a member such as the housing, and the housing may be connected to the end brackets 3, 4. In this case, since the end of the first fluid flow passage 11 is not in a position to reach the end brackets 3, 4, connecting tubes between the first fluid flow passage 11 and the second fluid flow passage and/or between the first fluid flow passage 11 and the third fluid flow passage may be added.

Further, the above description is concerned mainly with motors, but the present invention may be applied to generators.

1. A fluid-passage built-in type electrical rotating machine, which comprises:
a rotor fixed to a rotating shaft by means of a bearing;
a stator in rotating relation to the rotor with a gap between the rotor and the stator;
a housing surrounding the stator;
a pump turbine, fixed to one end of the rotating shaft, for circulating or transporting fluid in the electrical rotating machine;
a primary end bracket fixed to one end of the housing; and
a secondary end bracket fixed to the other end of the housing;
wherein the primary end bracket has a suction port for suctioning fluid into the electrical rotating machine, and the secondary end bracket has a discharging port for discharging fluid from the electrical rotating machine,
wherein the outer periphery of the stator and the inner face of the housing confines a first fluid flow passage extending along the axis of the rotating shaft, one end of the stator iron core and the primary end bracket facing the one end of the stator confines a second fluid flow passage and the other end of the stator and the secondary end bracket confines a third fluid flow passage, and
wherein the suction port, the first fluid flow passage, the second fluid flow passage, the third fluid flow passage and the discharging port are communicated.

2. The fluid-passage built-in type electrical rotating machine according to claim 1, which further comprises a pump turbine built-in the third fluid flow passage.

3. The fluid-passage built-in type electrical rotating machine according to claim 1, which further comprises a heat dissipating loop connecting the suction port and the discharging port, wherein the heat dissipating loop contains a cooling medium that circulates through the first, second and third fluid flow passages in the electrical rotating machine.

4. The fluid-passage built-in type electrical rotating machine according to claim 1, wherein the stator is made of a sintered magnetic body or a compacted magnetic powder body.

5. The fluid-passage built-in type electrical rotating machine according to claim 1, wherein the stator iron core is assembly of segments equally divided along the first fluid flow passage of the stator iron core.

6. The fluid-passage built-in type electrical rotating machine according to claim 5, wherein the assembly of the segments is accommodated in a cylindrical housing.

7. The fluid-passage built-in type electrical rotating machine according to claim 1, wherein the electrical rotating machine is a motor.

8. The fluid-passage built-in type electrical rotating machine according to claim 1, wherein the electrical rotating machine is a generator.

9. The fluid-passage built-in type electrical rotating machine according to claim 1, wherein a single first fluid flow passage is formed in the stator.

10. A fluid-passage built-in type electrical rotating machine, which comprises:
a rotor fixed to a rotating shaft;
a stator, made of a sintered magnetic powder body or a compacted magnetic powder body, in rotating relation to the rotor with a gap therebetween;
a housing surrounding the stator;
a pump turbine, fixed to one end of the rotating shaft, for circulating fluid in the electrical rotating machine;
a primary end bracket fixed to one end of the housing; and
a secondary end bracket fixed to the other end of the housing;
wherein the primary end bracket has a suction port for suctioning fluid into the electrical rotating machine, and the secondary end bracket has a discharging port for discharging fluid from the electrical rotating machine,
wherein the outer periphery of the stator and the inner face of the confines a first fluid flow passage extending along the axis of the rotating shaft, one end of the stator iron core and the primary end bracket facing the one end of the stator confines a second fluid flow passage and the other end of the stator and the secondary end bracket confines a third fluid flow passage, and
wherein the suction port, the first fluid flow passage, the second fluid flow passage, the third fluid flow passage and the discharging port are communicated.

11. The fluid-passage built-in type electrical rotating machine according to claim 10, wherein a seal groove is formed between the first fluid flow passage and the teeth portion, the seal groove being filled with a sealant or an O-ring.

12. The fluid-passage built-in type electrical rotating machine according to claim 10, wherein the housing, a stator, a rotor rotatably supported on a rotating shaft, the first end bracket and the second end bracket are fastened by bolts and nuts, the bolts penetrating the end brackets, the stator to constitute the electrical rotating machine.

13. The fluid-passage built-in type electrical rotating machine according to claim 10, wherein the stator iron core of the stator is a laminate of silicon-steel plates, the fluid being prevented from a contact with the laminate.

14. The fluid-passage built-in type electrical rotating machine according to claim 10, wherein the first fluid flow passages are formed at positions corresponding to the winding grooves.

15. The fluid-passage built-in type electrical rotating machine according to claim 10, wherein each of the fluid flow passages of a segment is formed in an equal distance along the circumference of the stator.

16. The fluid-passage built-in type electrical rotating machine according to claim 10, wherein the pump turbine is fixed to the shaft to be driven by the shaft.

17. A fluid-passage built-in type electrical rotating machine, which comprises:
a rotor fixed to a rotating shaft;
a stator in rotating relation to the rotor with a gap therebetween;
a pump turbine, fixed to one end of the rotating shaft, for circulating fluid in the electrical rotating machine;
a primary end bracket fixed to one end of the housing; and
a secondary end bracket fixed to the other end of the housing;
wherein the primary end bracket has a suction port for suctioning fluid into the electrical rotating machine, and the secondary end bracket has a discharging port for discharging fluid from the electrical rotating machine, and
wherein there are at least one fluid flow passage extending along the axis of the shaft, the flow passage being formed outside the gap between the rotor and the stator.

18. The fluid-passage built-in type electrical rotating machine according to claim 17, wherein the stator is made of a sintered magnetic powder body or a compacted magnetic powder body.

19. The fluid-passage built-in rotating machine according to claim 17, wherein the stator is divided into plural segments along the axis of the stator, the segments being assembled into the stator.

20. The fluid-passage built-in rotating machine according to claim 17, wherein the flow passage is formed between the outer periphery and the inner face of the housing.
